(19) United States
(12) Patent Application Publication
(10) Pub. No.: US 2002/0043134 A1
(43) Pub. Date: Apr. 18, 2002

(54) Locating and shifting structures of a movable joint of a ratchet screwdriver

(76) Inventor: Shih-Chi Ho, Taichung Hsien (TW)

Correspondence Address: Harrison & Egbert, 412 Main St., 7th Floor, Houston, TX, 77002, US

(21) Appl. No.: 09/957,605

(22) Filed: Sep. 21, 2001

(30) Foreign Application Priority Data
Oct. 12, 2000 (TW) 89217647

(51) Int. Cl. B25B 13/46

(52) U.S. Cl. 81/60

(57) ABSTRACT

A ratchet screwdriver comprises a handle, a main body, and a movable joint member fastened between the handle and the main body. The joint member is formed of a ratchet portion, and a locating device comprising a position confining slot, a recovery spring, and a retaining member. The retaining member is formed of a press portion and a retaining portion and is urged by the recovery spring such that the retaining portion is retained by the ratchet portion so as to fix the movable joint member, and that the retaining portion is forced to move away from the ratchet portion at such time when the press portion of the retaining member is exerted on by an external force, thereby enabling the movable joint member to swivel.

### BACKGROUND OF THE INVENTION

1. Field of the Invention

The present invention relates generally to a ratchet screwdriver, and more particularly to a movable joint of the ratchet screwdriver.

2. Description of Related Art

As shown in FIGS. 1 2, and 2A, a prior art ratchet screwdriver has a handle 11 which is provided at one end with a main body 12 extending therefrom for fastening a movable joint 10. The movable joint 10 is provided with a locating ring 13. The main body 12 is provided with an axial hole 15 having a core hole 14. The axial hole 15 is used to receive a shaft rod 18 having a gear 16 and a protruded pillar 17. The main body 12 is provided with an insertion slot 19 for inserting an insertion stop plate 20. The main body 12 is further provided with two check plates 21 and two side walls 121. The front end of the main body 12 is provided with a tubular housing 22 and a locking ring 24 having a center through hole 23.

In operation, the movable joint 10 is located by the locating ring 13 after the movable joint 10 is angularly adjusted. The check plates 21 are intended to stop the gear 16.

Such a prior art ratchet screwdriver as described above is defective in design in that the locating ring 13 does not allow a fast shifting of the movable joint 10, and that the side walls 121 are not rigid enough to sustain the pressure exerting thereon at the time when the gear 16 is confined by the two check plates 21, as illustrated in FIG. 2A.

### BRIEF SUMMARY OF THE INVENTION

The primary objective of the present invention is to provide a ratchet screwdriver with a movable joint member which is free of the deficiencies of the prior art ratchet screwdriver described above.

The ratchet screwdriver of the present invention is basically similar in construction to the prior art ratchet screwdriver described above, with the difference being that the movable joint member of the present invention is provided at one end with a ratchet portion and a locating device for locating the movable joint member in conjunction with the ratchet portion.

The features and the advantages of the ratchet screwdriver of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows an exploded view of a prior art ratchet screwdriver.

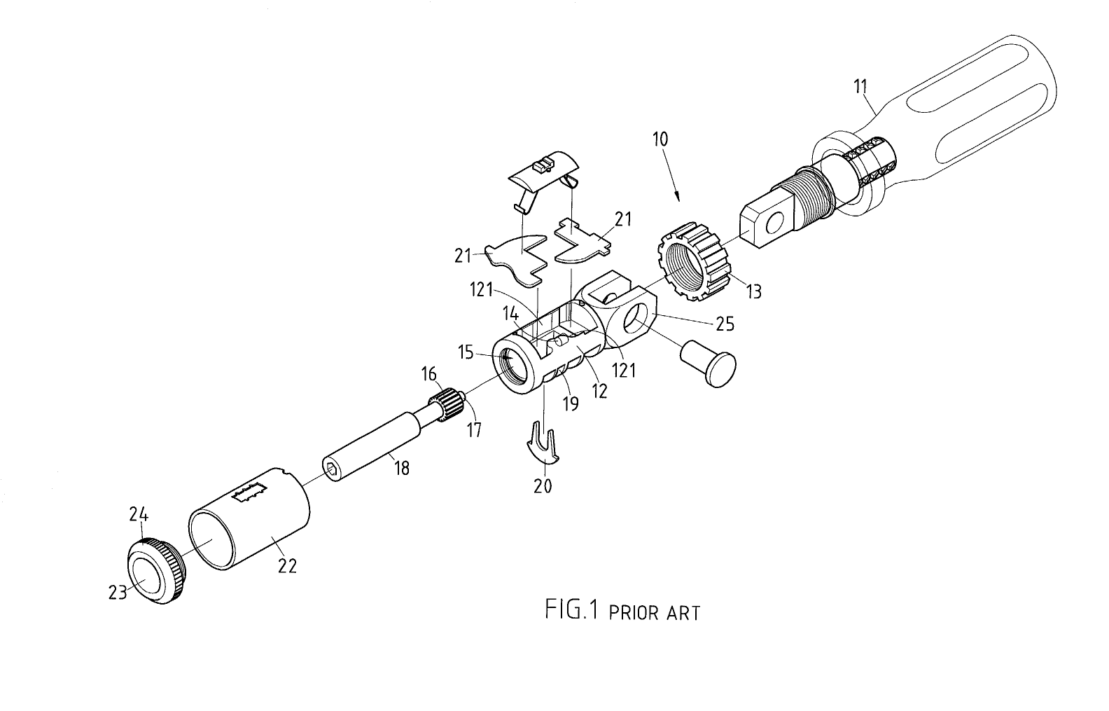

FIG. 2 shows a perspective view of the prior art ratchet screwdriver in combination.

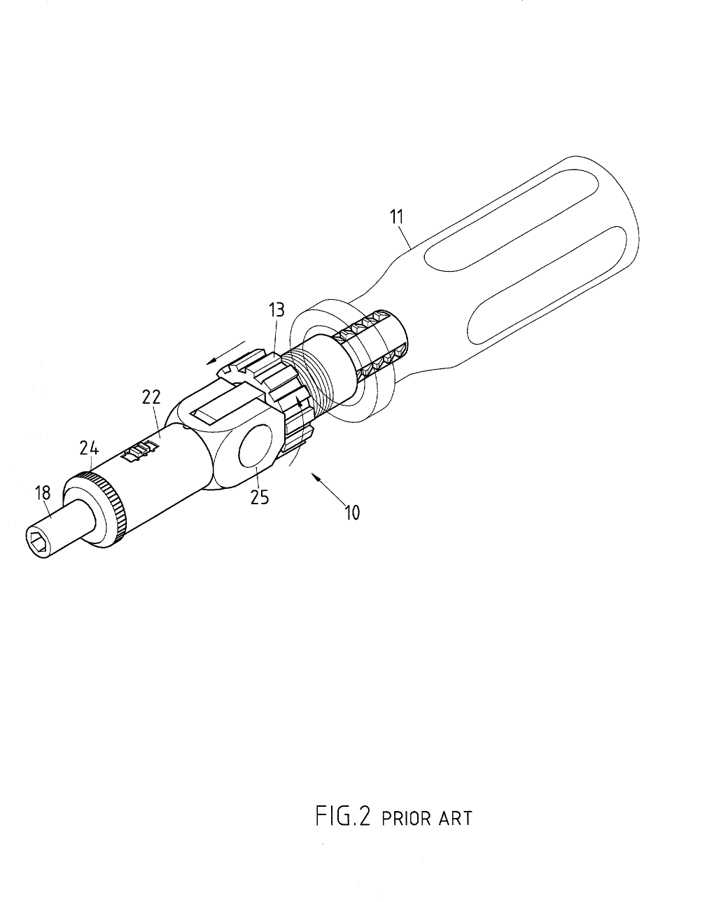

FIG. 2A shows a cross-sectional view of the prior art ratchet screwdriver as shown in FIG. 2.

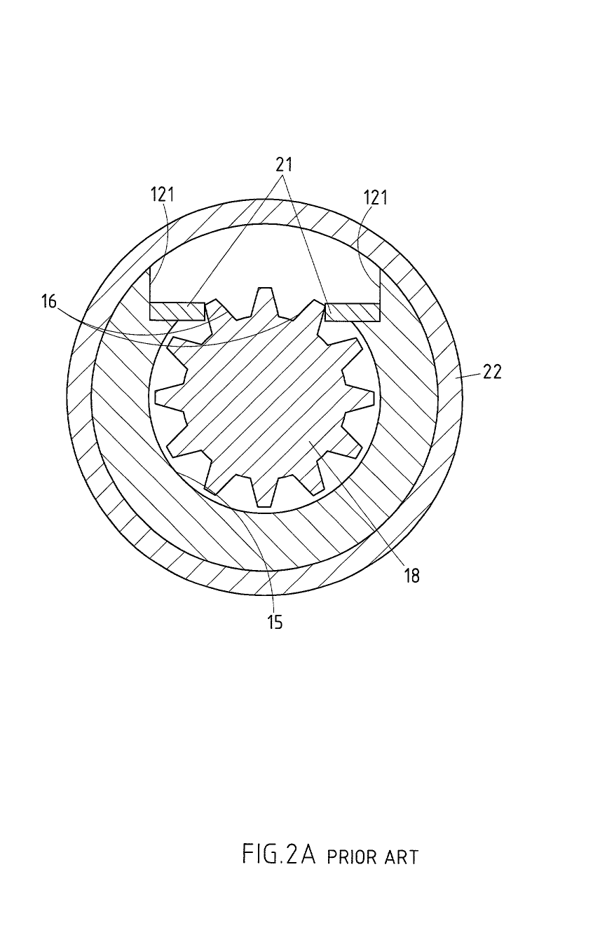

FIG. 3 shows a perspective view of a ratchet screwdriver of the preferred embodiment of the present invention.

FIG. 4 shows an exploded view of the ratchet screwdriver of the preferred embodiment of the present invention.

FIG. 5 shows a partial sectional view of the preferred embodiment of the present invention.

FIG. 6 shows a sectional view of the preferred embodiment of the present invention at work.

FIG. 7 shows a cross-sectional view of the preferred embodiment of the preset invention.

### DETAILED DESCRIPTION OF THE INVENTION

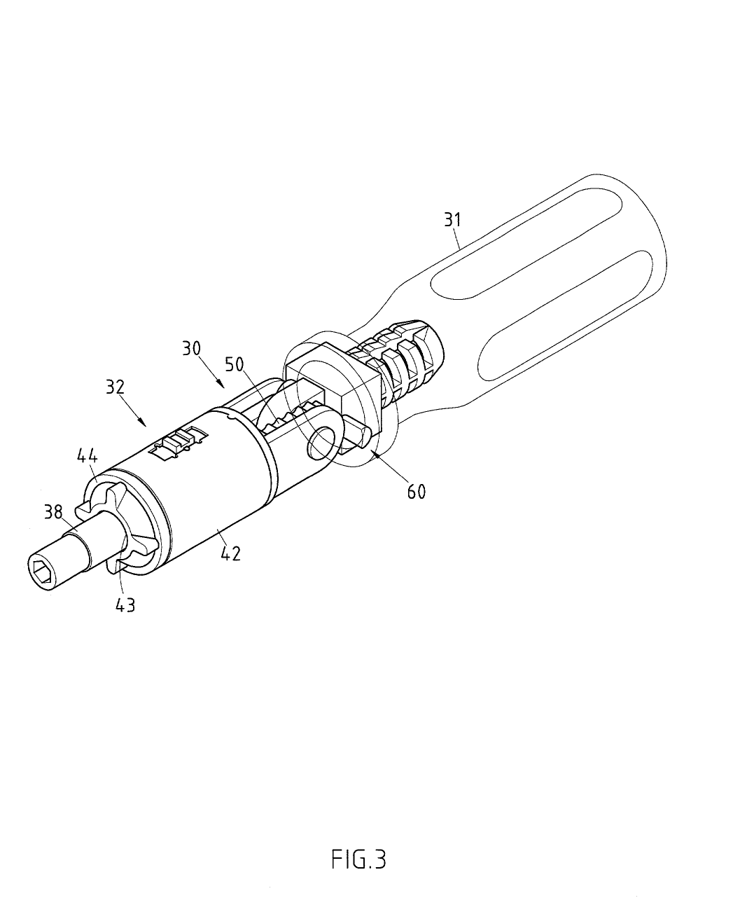

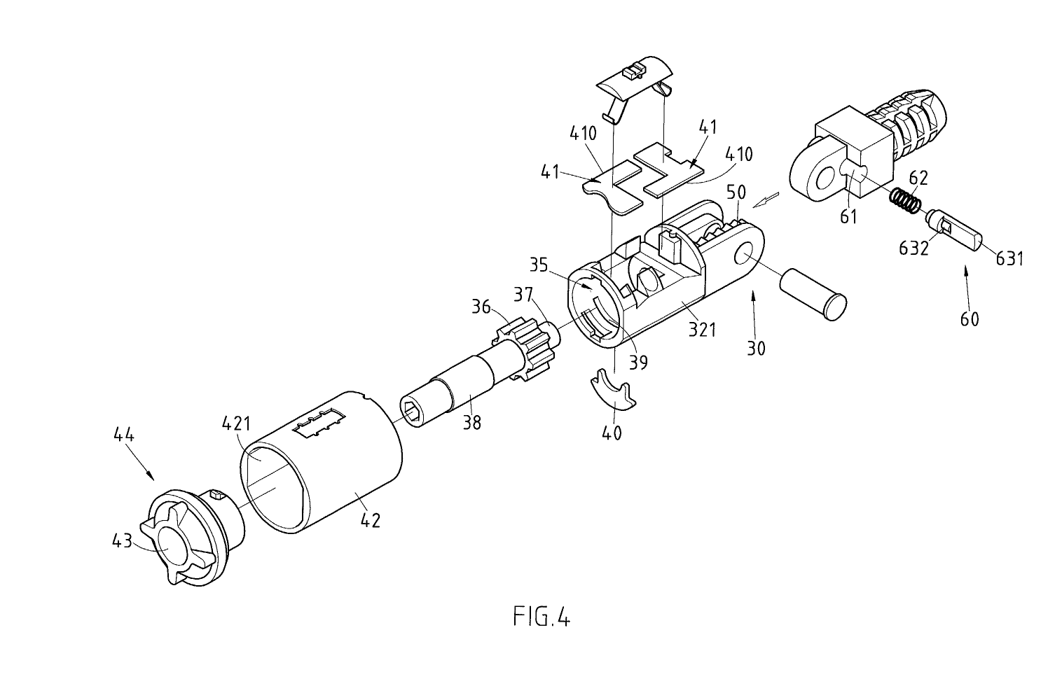

As shown in FIGS. 3-7, a ratchet screwdriver of the preferred embodiment of the present invention comprises a movable joint member 30 which is fastened at one end with a handle 31 of the ratchet screwdriver, and at other end with a main body 32 of the ratchet screwdriver.

The main body 32 is provided with an axial hole 35, and a shaft rod 38 which is provided with a gear 36 and a projection 37 and is disposed in the axial hole 35 in conjunction with two check plates 41, with each having a stop side 410. The main body 32 is further provided with an insertion slot 39 in which a stop plate 40 is disposed. The main body 32 is further provided with a sleeve 42 and a locking ring 44. The sleeve 42 is fitted over the main body 32, whereas the locking ring 44 is fastened with the outer end of the main body 32. The locking ring 44 has a center through hole 43 via which the outer end of the shaft rod 38 is jutted out of the outer end of the main body 32.

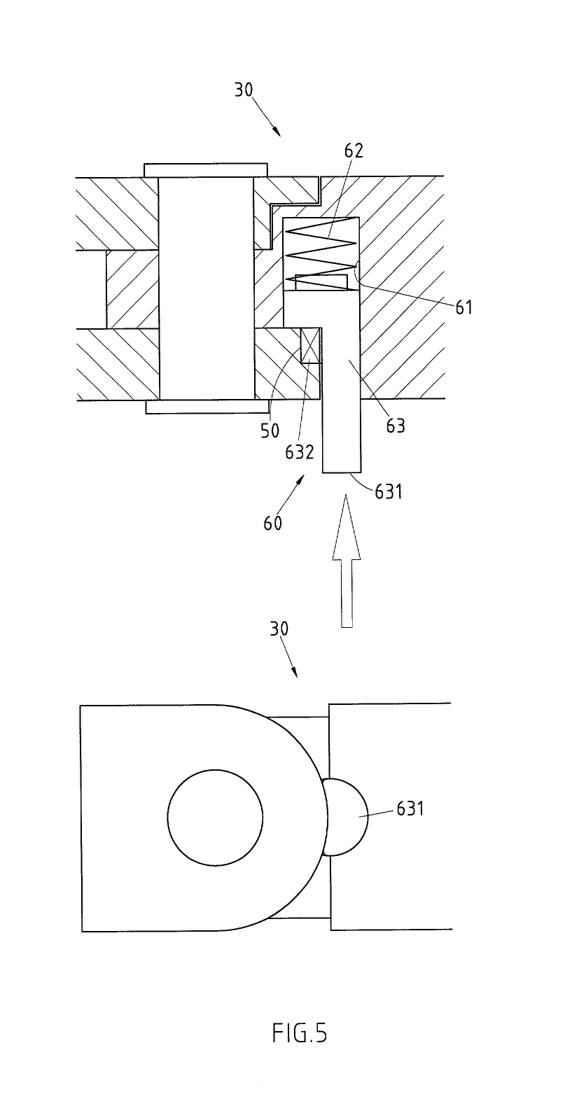

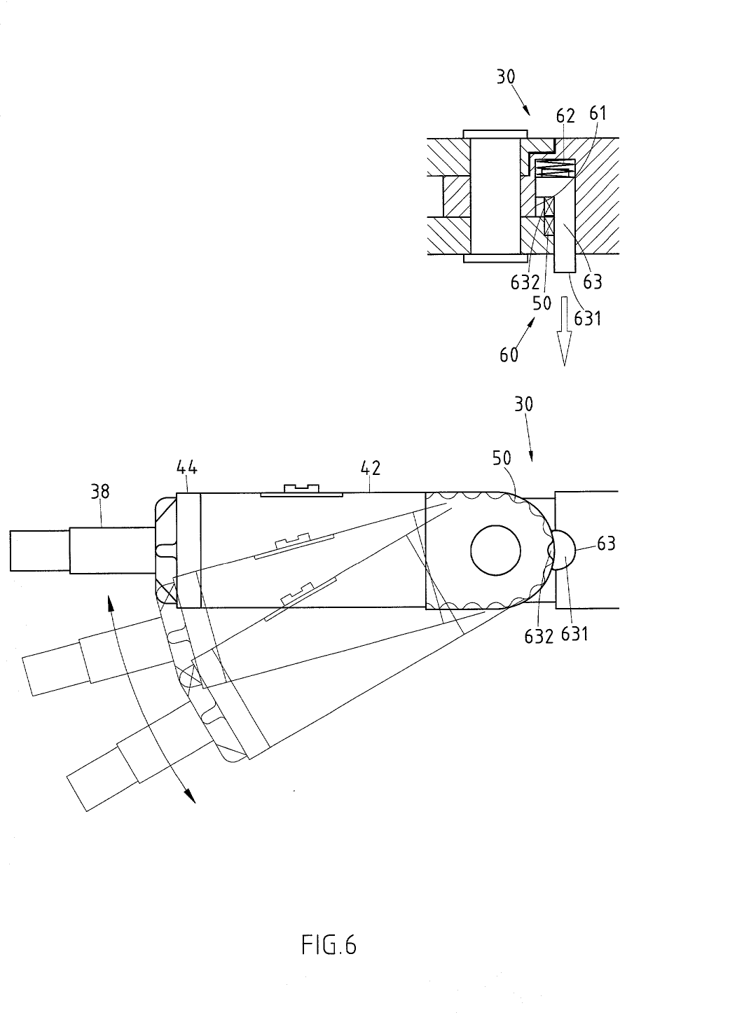

The movable joint member 30 is formed of a ratchet portion 50 and a locating device 60 which is pivotally fastened at one end with the ratchet portion 50, and at other end with the handle 31 of the ratchet screwdriver of the present invention. The locating device 60 comprises a position confining slot 61, a recovery spring 62, and a retaining member 63 which is formed of a press portion 631 and a retaining portion 632. The locating device 60 works in conjunction with the ratchet portion 50 to facilitate the shifting of the movable joint member 30 with ease and speed. As illustrated in FIG. 5, the retaining member 63 is urged by the recovery spring 62 such that the retaining portion 632 is retained by the ratchet portion 50, thereby causing the movable joint member 30 to be fixed. When the press portion 631 is exerted on by an external force, the retaining portion 632 is forced to move away from the ratchet portion 50, thereby enabling the movable joint member 30 to swivel, as illustrated in FIG. 6.

The main body 32 of the preferred embodiment of the present invention is provided in the outer wall with two indented edges 321 opposite to each other and extending along the longitudinal direction of the main body 32. The sleeve 42 is provided in the inner wall with two guide edges 421 corresponding to the indented edges 321 of the main body 32 and contiguous to the stop sides 410 of the check plates 41.

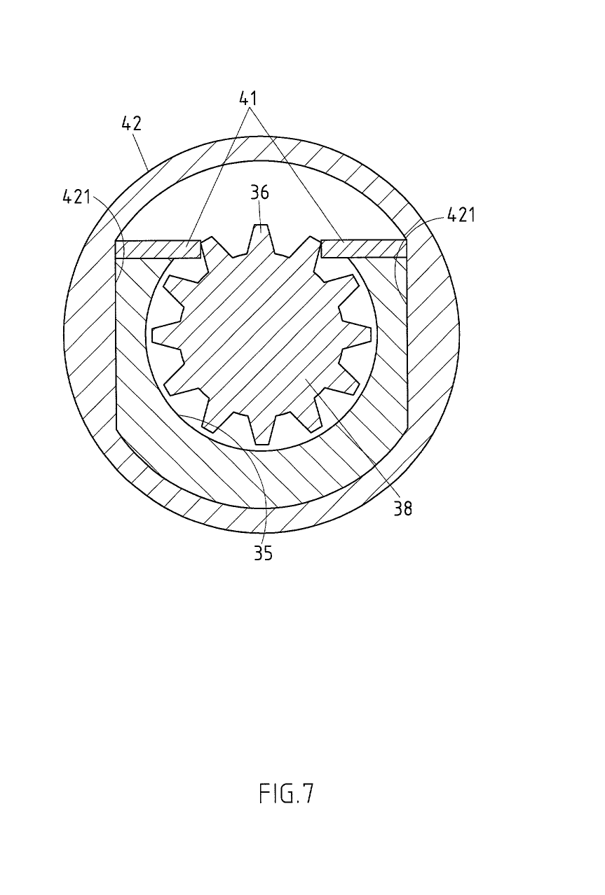

As shown in FIG. 7, when the gear 36 is arrested by the two check plates 41, the pressure is withstood by the guide edges 421 of the sleeve 42. In light of the guide edges 421 of the sleeve 42 of the present invention being greater in rigidity than the side walls 121 of the main body 12 of the prior art ratchet screwdriver, the ratchet screwdriver of the present invention is capable of withstanding a greater torsion as compared with the prior art ratchet screwdriver.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following claim.

I claim:

1. A ratchet screwdriver comprising:
a handle;
a main body provided with an axial hole, a sleeve fitted thereover, a shaft rod having a gear mounted on an inner end thereof, a locking ring fastened with an outer end of said main body and provided with a center through hole via which an outer end of said shaft rod is jutted out of the outer end of said main body, said shaft rod being disposed in said axial hole of said main body in conjunction with two check plates, each having a stop side, said main body further provided with an insertion slot and a stop plate disposed in said insertion slot; and
a movable joint member fastened between said handle and said main body such that said movable joint member is adjustable in angle in relation to said handle;
wherein said main body is provided in an outer wall with two indented edges opposite to each other and extending along the longitudinal direction of said main body; wherein said sleeve is provided in an inner wall with two guide edges corresponding to said indented edges of said main body and contiguous to said stop sides of said check plates;
wherein said movable joint member is formed of a ratchet portion fastened with an inner end of said main body, and a locating device which is fastened pivotally at one end with said ratchet portion and at other end with said handle, said locating device comprising a position confining slot, a recovery spring, and a retaining member formed of a press portion and a retaining portion, said retaining member being urged by said recovery spring such that said retaining portion is retained by said ratchet portion, so as to fix said movable joint member whereby said retaining portion is forced to move away from said ratchet portion at such time when said press portion of said retaining member is exerted on by an external force, thereby enabling said movable joint member to swivel.
